(19) United States
(12) Patent Application Publication
(10) Pub. No.: US 2004/0158999 A1
(43) Pub. Date: Aug. 19, 2004

(54) Compensating skeletal geometric modeling system

(76) Inventor: Wayne Douglas Trantow, Portland, OR (US)

Correspondence Address: Keith A. Cushing, Patent Cooperation Treaty, 4201 S.W. Vacuna St., Portland, OR, 97219, US

(21) Appl. No.: 10/777,568

(22) Filed: Feb. 12, 2004

Related U.S. Application Data
(60) Provisional application No. 60/448,406, filed on Feb. 19, 2003.

(51) Int. Cl. B43L 7/10

(52) U.S. Cl. 33/452

(57) ABSTRACT

A strut for a geometric modeling includes a shaft section having a first end and a second end, a first node connector element, a second node connector element, a first flexible section coupling the first node connector element and the first end, and a second flexible section coupling the second node connector element and the second end.

### CROSS-REFERENCE TO RELATED PROVISIONAL APPLICATION

The present application claims priority relative to provisional patent application Serial No. 60/448,406 filed by applicant herein on Feb. 19, 2003 and entitled COMPENSATING SKELETAL GEOMETRIC MODELING SYSTEM.

### BACKGROUND OF THE INVENTION

Skeletal geometric modeling includes construction of geometric structures in support of educational or hobby activities. A high degree of complexity and accuracy supports meaningful representation of geometric structures from simple structures to more complex structures. Typically, skeletal geometric modeling systems consist of struts and nodes. The intersection of two or more struts in three-dimensional space, for example, creates a node. An important design characteristic is how struts are attached and fixed at the node. This characteristic determines how conveniently one builds a geometric model and how complex the model can become.

A geometric modeling system often functions as an educational tool—a tool of discovery. An effective educational tool enables the construction of geometric structures containing a large number of nodes and revealing complex spatial patterns that are difficult, if not impossible, to mentally imagine beforehand. The means of construction is preferably intuitive—first to build basic geometric structures, regular polyhedrons for example, and then to build upon these basic structures to form even more complex geometric structures.

There are several known geometric modeling system designs. Most, if not all, of these designs impose practical limits on model complexity, e.g., node count. Building a model with a large number of nodes using known modeling systems can be very difficult in practice.

Modeling systems can be skeletal or non-skeletal in design principle. Some non-skeletal systems allow build-out of polyhedral structures by attaching two-dimensional (2D) geometric panels (e.g., triangles, squares, etc.) together on their edges to form three-dimensional (3D) structures. For example, four similar equilateral triangle panels attached at their edges form a tetrahedron. Other non-skeletal systems are simply solid blocks made from such materials as wood, plastic or sponge. The blocks provide some means of attaching at their facets to create a larger shape. These types of modeling systems, however, do not scale well beyond basic structures. For example, with a modeling system that uses panels it is very difficult, if not impossible, to build-out from a simple tetrahedron to form an icosahedron, a structure composed of twenty tetrahedrons emanating out from a single common vertex. Thus non-skeletal systems do not promote discovery of new complex forms through experimental additions of more model elements.

This same general limitation also applies to most commercially available skeletal geometric modeling systems. These systems are typically of the “stick and hub” design. Consider commercial geometric modeling toys TinkerToys®, Ramagon® and Zometools®, or the construction toy described in U.S. Pat. No. 6,491,563. These designs provide the model builder with a plurality of struts and node hubs. The node hub is typically a sphere with multiple holes positioned in the shell per mathematical formula. The ends of the struts are shaped so that they mate exactly into the holes in the node hub. To build-out a structure, strut pieces are inserted into specific holes to form particular 3D patterns. This design principle limits the usefulness of these products in more than one way. First, because strut length and the position of the holes in the hubs are pre-determined by the manufacturer, the builder must know beforehand which holes to connect the strut into. Here the building experience is one of following a set of assembly instructions to achieve a particular end result, not free experimentation that leads to discovery of new structures as promoted by embodiments of the invention. Secondly, to achieve a high degree of build-out in 3D space, the relative position of nodes in 3D space to one another has to be very accurate. Any error in a node's position is additive. As nodes are added, positional error accumulates to the point where two nodes cannot be connected by a strut because the distance between them is either too short or too long. Thus the build-out ends, the model cannot grow. In systems, such as Ramagon® and Zometools® where strut and hub dimensions are fixed and rigid, it is virtually impossible to manufacture node angles and strut lengths so accurately that positional error can be totally eliminated.

An important fundamental limitation of these systems is that there is nothing to compensate for this inherent and cumulative error and, as a result, the size potential of structure build-out is limited compared to embodiments of the invention as described more fully hereafter.

Another stick and hub system, Dynamagz®, uses struts that are tipped with magnets. Spherical iron balls function as nodes. This system allows a freer approach to attaching struts together because there are no pre-determined holes to attach struts to. Instead, the direction the ultimate structure takes is guided by observations of the model builder as construction takes place. This system, however, uses statically dimensioned components that cannot compensate for node positional error and thus the number of nodes a structure can ultimately support is limited. Another limiting factor is the weight of the components. Eventually, the overall weight of the structure becomes greater than what the magnetic bonds can hold and the structure collapses, thus ending node build-out.

Another fundamental limitation of all the aforementioned skeletal modeling systems is that they do not allow practical integration of sub-structures.

Thus, geometric modeling systems typically do not allow a model builder to explore as many 3D geometric variations as desired or visualized. It would be desirable, therefore, to provide a geometric modeling system supporting build-out of a large number of nodes with an intuitive, easy to perform means of assembly.

### SUMMARY OF THE INVENTION

A strut for a geometric modeling includes a shaft section having a first end and a second end, a first node connector element, a second node connector element, a first flexible section coupling the first node connector element and the first end, and a second flexible section coupling the second node connector element and the second end.

The subject matter of embodiments of the present invention are particularly pointed out and distinctly claimed in the concluding portion of this specification. However, both the organization and method of operation of embodiments of the present invention, together with further advantages and objects thereof, may best be understood by reference to the following description taken with the accompanying drawings wherein like reference characters refer to like elements.

### BRIEF DESCRIPTION OF THE DRAWINGS

For a better understanding of embodiments of the present invention, and to show how the same may be carried into effect, reference will now be made, by way of example, to the accompanying drawings in which:

FIG. 1a is a front view of a generic end-tab piece and side view profiles of two variations of same piece.

FIG. 1b contains front views of variations of the generic end-tab piece of FIG. 1a FIG. 1c is a perspective view of a ribbed node pin and a lateral side-view of a ribbed node pin and one variation of a node pin that contains a compressible sheathing instead of ribs to hold an end-tab in place.

FIG. 1d is a perspective view of the interior, generally, rigid shaft of a strut.

FIG. 2a is a perspective view of an exemplar of a strut assemblage including a single hollow shaft with flexible end-tab pieces inserted into each of its ends.

FIG. 2b is a side-view of the strut assemblage of FIG. 2a.

FIG. 3 is a top view of a partially constructed tetrahedron lying in 2D plane.

FIG. 4 is a perspective view of a completed tetrahedron and a magnified top view of one node, with a subset of end-tabs, shown to exhibit the relationship of end-tabs to a node pin.

FIG. 5 is a perspective view of an icosahedron structure.

FIG. 6 is a perspective view of two icosahedron structures being bonded into a single, larger structure and a magnified side-view of the mated node showing the consolidation of a subset of end-tabs onto one node pin.

FIG. 7a is a front view of an alternative end-tab.

FIG. 7b is a perspective and side view of an alternative “pin and collar” node pin.

FIG. 8a is a profile view of an alternative “push-pull” node pin in its rest state.

FIG. 8b is a profile view of the ‘push-pull’ node pin of FIG. 8a in its stretched state.

FIG. 9a is profile view showing an end-tab being fastened onto the ‘push-pull’ node pin of FIGS. 8a and 8b.

FIG. 9b is a profile view of two end-tabs fastened and held in place the “push-pull” node pin of FIGS. 8a and 8b in its rest state.

FIG. 9c is a front view of a single end-tab showing comparative size of the end-tab hole to the ends of two push-pull node pins stacked and ready for a bonding operation.

FIG. 10a is a profile view of an alternative “squeeze-clip” node pin in its rest state.

FIG. 10b is a profile view of the “squeeze clip” node pin of FIG. 10a, but in its compressed or squeezed state and a strut being attached to the node pin.

FIG. 10c is a profile view of two struts being held in place by the “squeeze clip” node pin in its rest state.

FIG. 10d is a profile view of the initial, overlay positioning of two nodes at the start of a node bonding operation.

FIG. 10e is a profile view of the transfer action of a set of struts being removed from one node pin and added to another node pin.

FIG. 10f is a profile view of a completed strut transfer operation.

FIG. 11a is a profile view of an alternative end-tab design accommodating strut tubes of varying diameter.

FIG. 11b is a profile view of the end-tab of FIG. 11a inserted into a comparatively small diameter strut tube.

FIG. 11c is a profile view of the end-tab of FIG. 11a inserted into a comparatively large diameter strut tube.

### DETAILED DESCRIPTION OF EMBODIMENTS OF THE INVENTION

Interlocking a plurality of length-proportioned struts at their end points forms complex multi-dimensional skeletal geometric models. Each strut has a resiliently flexible flat end piece with a hole at its outer extremity. Multiple struts intersect at the point where their holes are pinned upon, for example, a rigid cylindrical shaft piece forming a stack of end-pieces that lie in the same plane perpendicular to the axis of the shaft piece. Two independently built models can be bonded at a facet or at a single node point by displacing the end-pieces from one pinning shaft onto the other pinning shaft and thereby forming a single intersected node. As described more fully hereafter, pinning shafts can be replaced by other forms including, but not limited to spring-form or clipping-form structures each having an ability to join in parallel stacked relation a set of flat strut ends or, as referenced herein, as set of stacked end-tabs forming a structure node.

According to particular embodiments of the invention, a skeletal geometric modeling system includes a plurality of strut and node pieces. Geometric structure build-out occurs as a multitude of struts are connected together at their end points to form nodes. A node is the intersection of the flat end-tabs of multiple struts from multiple directions fixed in place by the node pin. A particular pattern of nodes in 3D space defines a particular geometric structure. The design of the strut and node pieces of embodiments of the invention make it very simple to connect struts together to create nodes and thus build out very sophisticated 3D geometric models. The design of the strut and node pins also makes it very simple to bond together independently built 3D structures to form an even more complex, unified structure. The design of the illustrated strut pieces allows for strut length modification so that experimentation with mathematical ratios of strut lengths can be modeled by the system.

Accordingly several objects and advantages of embodiments of the invention are to provide an improved three-dimensional geometric modeling system, to provide means of affixing struts together to form the nodes (i.e., vertices) of geometric structures in an intuitive manner that does not require the builder to pre-conceive the final intended form, to provide means of bonding two geometric structures together by consolidating two separate nodes into one node, to provide means of changing strut lengths so as to model the effects of various mathematical ratios on 3D geometric form. The fundamental characteristic of embodiments of the invention is an exploratory tool that provides means for deep study of the organization of physical structures in space.

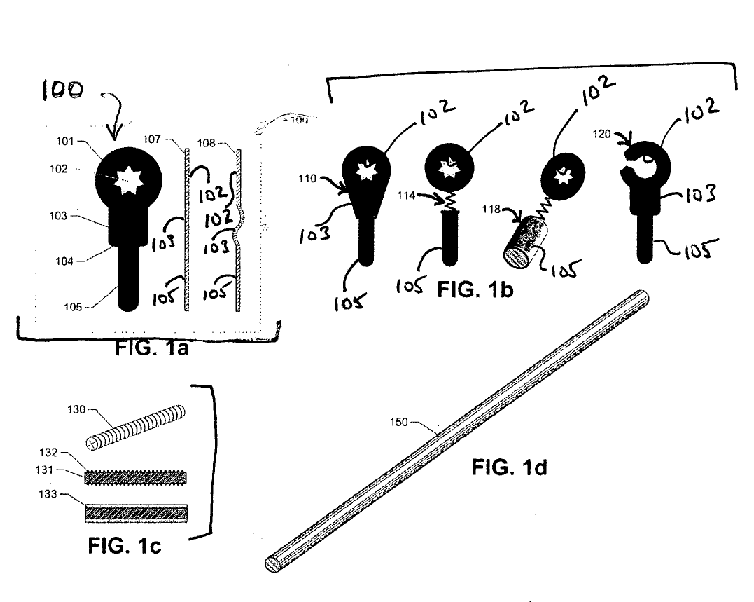

FIG. 1a shows a flat, flexible end-tab 100 with profile variations 107 and 108. End-tab 100 enables multiple struts to intersect from varied directions onto a single node pin as described in various forms hereafter. In a generic form of end-tab 100, a planar tab face 101 contains a hole 102 of pre-determined size and location on face 101 of end-tab 100. Section 103 is a flexible section of end-tab 100 between tab face 101 and insertion section 105. Flexing section 103 allows the tab face 101 to bend and twist relative to section 105 and thus align perpendicular to a node pin and flat against other end-tabs 100 in stacked relation. Flexing section 103 also provides spatial error compensation by allowing the strut to vary length. End-tab 100 can be flat as in profile variation 107. In profile variation 108, end-tab 100 includes a “corrugated” section 103 flexible to a degree needed to complete a node intersection by contraction and extension. Similar contraction and extension occurs in end-tab design 114 (FIG. 1b).

For simplicity and clarity, end-tab 110 (FIG. 1b) and node pin 130 (FIG. 1c) have been chosen as the exemplar components in many of the operations and diagrams herein. Several alternative end-tab and node pin designs are also described. As used herein, the terms “end-tab” and “tab” are generally synonymous, and the terms “node pin” and “pin” are generally synonymous.

End-tab 110 is has a serrated hole 102 that works with the ribbed node pin 130. There are two diameters in the serrated hole 102 that are of interest: the smaller diameter measured at the teeth tips in serrated hole 102, and the larger diameter measured at the base of the teeth of serrated hole 102. The two diameters of hole 102 are sized to operate correctly with the diameters of the rib and core diameters of node pin 130.

Tab stop 104 ensures that the end-tab is inserted to a consistent depth into the strut shaft 150 (FIG. 1d). This ensures that all struts with shafts 150 of equal length will also be of equal length after the end-tabs 100 are inserted. The width and thickness of tab insertion section 105 and the inner diameter of the tube-shaped shaft 150 are sized such that tab insertion section 105 grips firmly to the inside wall of tube-shaped shaft 150. Appropriate sizing of the insertion section 105 dimensions to the inside diameter of tube 150 allows the builder to easily insert the end-tab 100, yet friction against the inside wall of the tube-shaped shaft 150 should be sufficient to hold end-tab 100 in place under the normal pulling tension exerted by the geometric structure.

FIG. 1b shows potential variations in the end-tab design. In variation 110 (FIG. 1b), flexible section 103 is simply a taper of flat sheet plastic from face 101 to tab stop 104 with side profile 107 as illustrated at reference numeral 107 (FIG. 1a). End-tab 110 with profile 107 allows flexing and longitudinal contraction of the strut, which is adequate for complex structure building. Furthermore this is likely a relatively less expensive design to manufacture. Alternatively, a flexible section 103 using profile 108 (FIG. 1a), or the helical coil design of 114 (FIG. 1b), allows both longitudinal contraction and stretching of the overall strut length. This design provides superior strut functionality but is likely to be relatively more expensive to manufacture than end-tab 110 with profile 107. It is important to note that without flexing section 103 incorporated into the design of flexing end-tab 100, and other end-tabs as described herein, the strut would be rigid virtually from shaft 150 to hole 102, the node point. Such a design would not compensate for inherent spatial error.

End-tab 118 illustrates an end-tab with a cylindrical cap for the insertion section 105. The interior diameter of the cap is sized so that it grips snugly to the outside of a strut shaft. It will also be appreciated that methods other than friction may be used to affix the end-tab to the rigid shaft. Glue, a physical clip or other means could also be used but may add unwanted complexity to the building process.

Alternative end-tab 120 has a slotted opening in tab face 101 such that it can be positioned onto node pin 130 by a lateral motion, like putting handcuffs laterally onto a node pin.

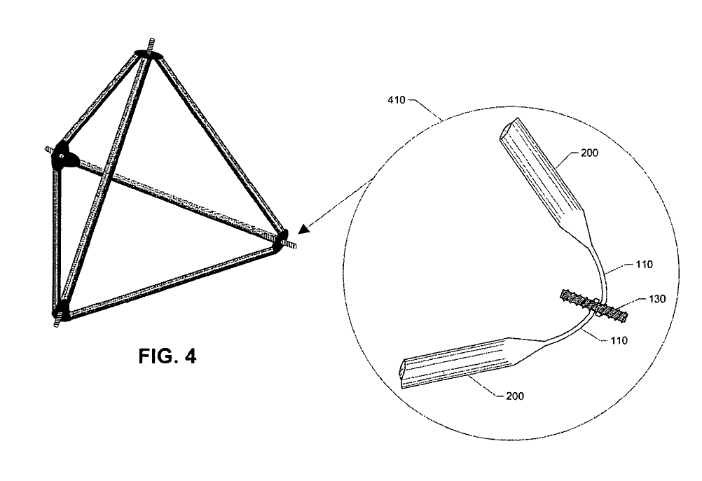

FIG. 1c shows the design of a node pin 130. It is a rigid cylindrical rod with a series of parallel ribs running perpendicular to its long axis. The spacing between each rib along the axis is approximately equal to the thickness of one or two flat end-tabs. Like the end-tab hole 102, there are two diameters of interest in node pin 130: the smaller diameter measured at the core and the larger diameter measured at the outside of the ribs. The diameter of hole 102 at the tips of its teeth is sized such that it is larger than the node pin's inner core diameter but smaller than the outer diameter of the node pin. Thus, the end-tab is designed to slide down the node shaft with a pre-determined resistance. The teeth click into the space between the ribs as it slides down the pin 130. Once situated at the desired position along the axis of the node pin 130 the end-tab can be freely rotated 360 degrees around the axis of node pin 130, but because the teeth of serrated hole 102 fit in between the ribs of the node pin, the face 101 is fixed semi-permanently along the axis of the node pin until the builder purposefully slides it to a new position. At the resting position on node pin 130, the tab face 101 lies flat. In this way multiple tab faces 101 can be stacked closely in parallel along the axis of node pin 130 as illustrated in FIG. 4.

A node pin could be fashioned without hard ribbing, but with a compressible sheath as illustrated in the alternative and in lateral interior or cross-sectional view as pin 133. Here the teeth of serrated hole 102 can be designed to dig slightly into soft or compressible sheathing as it slides down the pin 133. This slight gripping action prevents unintentional sliding of the end-tab along the node pin 133 once in position.

An important characteristic of the illustrated modeling system is reuse of components. It will be appreciated that embodiments of the invention not only allow for easy construction of structures, but also, easy teardown of structures. To disassemble a structure, the builder need only pull the node pins out of the nodes to free the struts. They are then ready to use for another build-out.

FIG. 1d shows a strut shaft as a rigid or semi-rigid tube made from common material, such as for example polyethylene, that is easily cut to any desired length by the builder. A semi-rigid plastic drinking straw is a good exemplar strut 150. The builder may use scissors or other common home and office cutting tools to cut the material. An alternative embodiment is a strut 150 that contains a solid shaft, made from materials such as wood or rigid plastic, with a tubular tab cap 118 (FIG. 1b) inserted over each end thereof to attach an end-tab.

It will be appreciated that the dimensions of the flexible end-tab shape and thickness, the dimensions of the node pin, the diameter of the shaft tube and thickness the tube wall are all appropriately proportioned to one another. As noted, the strut shaft can be allowed to vary in length for experimentation with mathematical ratios of strut lengths. The practical working length of the strut is dependent upon the tube diameter and wall thickness. If the strut is too long for its diameter and wall thickness, it may buckle under the load of normal model tension. Strut length is also dependent upon practical human scale. For example, if struts are too long, a structure can easily grow larger than the size of a typical room. If strut length is too short, it becomes difficult for the builder to assemble structure because there is not enough room for the hands to reach inside the structure. Another human factor that is considered is the length of the node pin. It must be long enough to be easily gripped by fingers and manipulated so that end-tabs can be slid onto it.

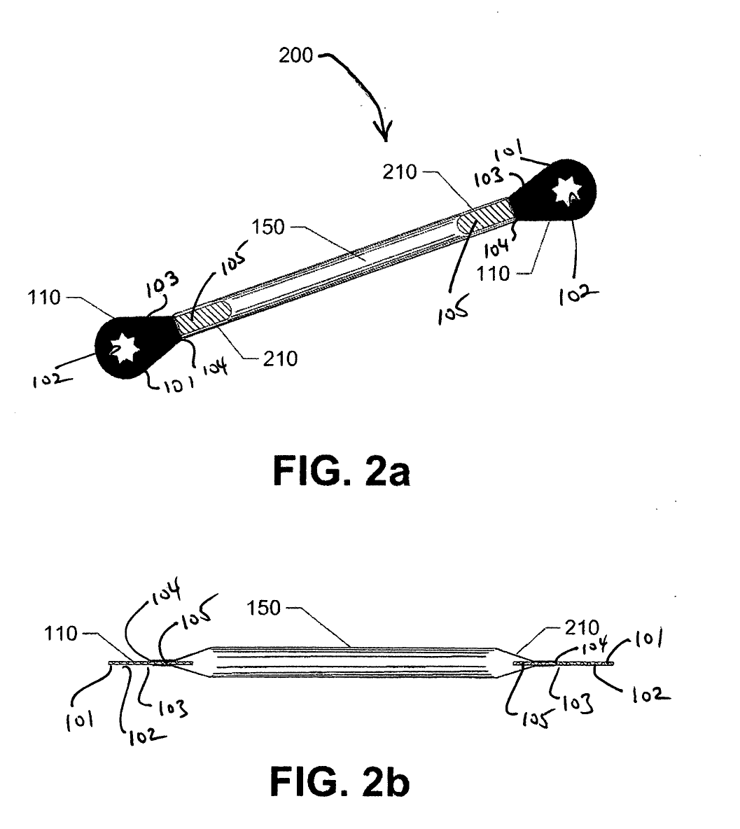

FIG. 2a is a perspective view of an assembled strut 200. FIG. 2b is a lateral side view of strut 200. As will be appreciated, strut 200 could be formed in monolithic fashion and appear as illustrated. FIG. 2a illustrates formation of strut 200 as a combination of two end-tabs 110 coupled by a shaft 150 therebetween. In the particular embodiment illustrated, the relative dimensions of insertion section 105 and inner diameter of shaft 150 cause the ends of shaft 150 to flatten as the relatively wider insertion section 105 is forced into shaft 150. Two flexible end-tabs 110 are shown inserted into the ends of the shaft 150 to form finished strut 200. Each end-tab 150 has been inserted up to tab stop 104. Transition zone 210 occurs at the end of tube 150 where the flat insertion section of tab grips the inner wall of tube 150. The distance from one tab hole 102 to the opposite tab hole 102 defines the approximate working length of the strut 200, although the length can vary slightly, by virtue of flexible sections 103, to compensate for spatial errors that occur as a structure is built-out. Flexible section 103 of the end-tab provides spatial error compensation by virtue of its ability to flex, stretch and contract. Therefore, by design, embodiments of the invention do not require perfect equality in the length of all struts 200. In fact, perfect length equality is unachievable for any modeling system.

Embodiments of the invention purposefully provide struts able to flex, twist, stretch or contract to accommodate the distance between two nodes that are to be connected. Because of this compensation mechanism, the entire structure is allowed to bring itself into a spatial equilibrium. If this spatial compensating mechanism were missing, as it is in other known modeling systems, structure build-out eventually stops at a point where the distance between two neighboring nodes does not equal the length of a static strut and thus can't be bridged.

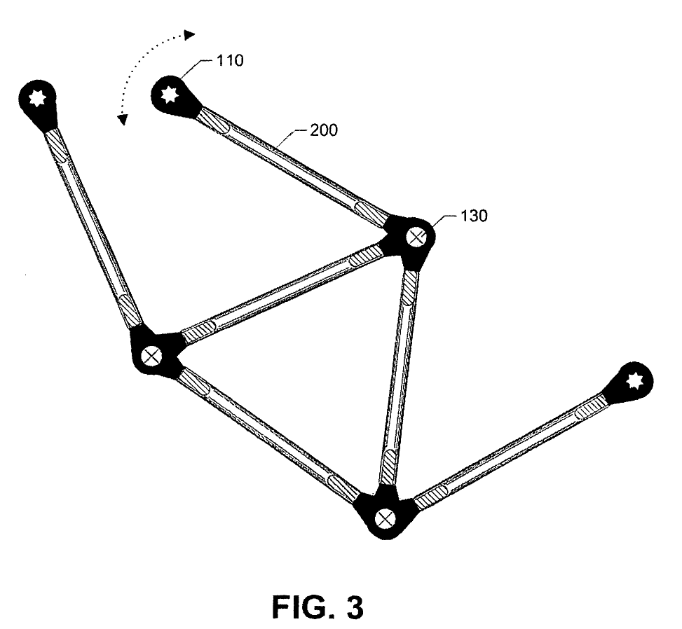

FIG. 3 is a top view of a collection of struts 200 about to be formed into a tetrahedron. This view illustrates how easy it is to fashion a 3D structure. Because struts 200 can rotate around the axis of the node pins, e.g., pins 130 in FIG. 3, it is very simple to connect struts 200 into a 2D triangle shape. It will be appreciated that when assembling a structure, the builder does not have to think about the angle of the struts emanating from the node, as one would if the node was something like a spherical hub with interface holes fixed at pre-determined angles. In embodiments of the invention, the builder only has to slide an end-tab, e.g. end-tab 110, onto a node pin, e.g., pin 130, and then rotate the strut 200 so that it intersects correctly with other corresponding struts 200. In FIG.3, once the 2D triangle is assembled, one additional strut is slid over each node of the 2D triangle. The un-terminated ends of the three dangling struts 200 are then rotated and flexed up in 3D space so that they intersect at their un-terminated ends. A node pin is then inserted to fix the intersection and a tetrahedron is created.

FIG. 4 is a perspective view of a completed tetrahedron and includes a magnified side view of a subset of end-tabs 110 of one node is shown at reference numeral 410. Both views illustrate how a node is formed by stacking tab faces 101 flatly upon each other and are fixed by node pin 130. It should be noted that in embodiments of the invention, a node forms as a physical plane that is perpendicular to the node pin. Subsequent additions of end-tabs onto the node pin can occur from either end of the node pin. When two structures are bonded together at their nodes, their corresponding nodes come together in the same plane.

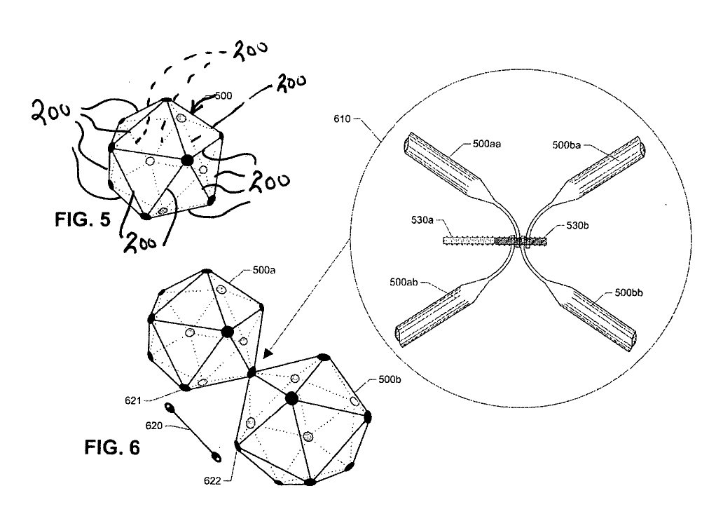

FIG. 5 is a perspective view of a single, skeletal icosahedron 500 formed from struts 200.

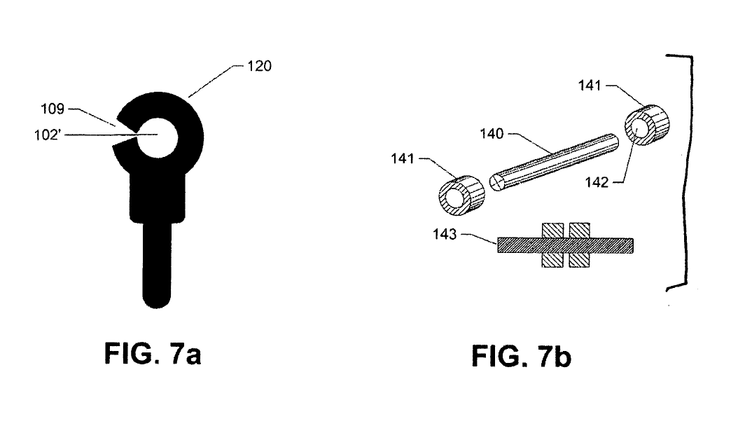

FIG. 6 is a perspective view of two icosahedrons 500a and 500b that are bonded at one node and includes a detail view at reference numeral 610 showing a particular node shared therebetween. Multiple geometric structures can be bonded together at their nodes to create a larger structure that maintains geometric integrity. This feature allows a divide-and-conquer strategy for building complex structures from a collection of simpler structures. Detail at reference numeral 610 shows a subset of the consolidated node of icosahedron 500a bonded to icosahedron 500b. Further integration of the two structures occurs when struts are connected between other nearby nodes of the two structures. For example, strut 620 is shown as it is about to be connected between nodes 621 and 622. This action may be repeated to all other similarly positioned nodes to completely bond the two icosahedrons and thus create a new form.

Detail viewed at reference numeral 610 illustrates the bonding action. Node pins 530a and 530b are first positioned end-to-end then all the end-tabs on node pin 530a are slide over onto node pin 530b. In the illustration, the end-tabs of struts 500aa and 500ab are shown stacked flatly against the end-tabs of struts 500ba and 500bb forming a single node that now has twice as many end-tabs. The thickness of tab face 101 is sized to be as thin enough to maintain a predetermined amount of resiliency while minimizing the overall thickness of any node. When multiple end-tabs are stacked upon the node pin, the thickness of each end-tab multiplied by the number of intersecting end-tabs will create a spatial deviation error between the two outermost end-tabs on the pin. In practice, a typical node will not have more than about ten end-tabs. Spatial error of this degree is compensated for by, for example, flexible section 103.

Although a limited number of profiles of hole 102 and designs of node pins are illustrated, it will be appreciated that useful variations in the design of tab hole and node pin are possible. Essentially, workable designs of these components will align in sandwiched or stacked fashion with faces 101 against each other on a node pin. Useful designs will allow convenient placement of tabs onto a node pin by intuitive, easy-to-learn, hand actions, yet by design, unintentional displacement of end-tabs off the pin by normal tension exerted by the weight of the model is prevented. Model disassembly should be easy, achieved simply by pulling node pins out of the intersected end-tabs.

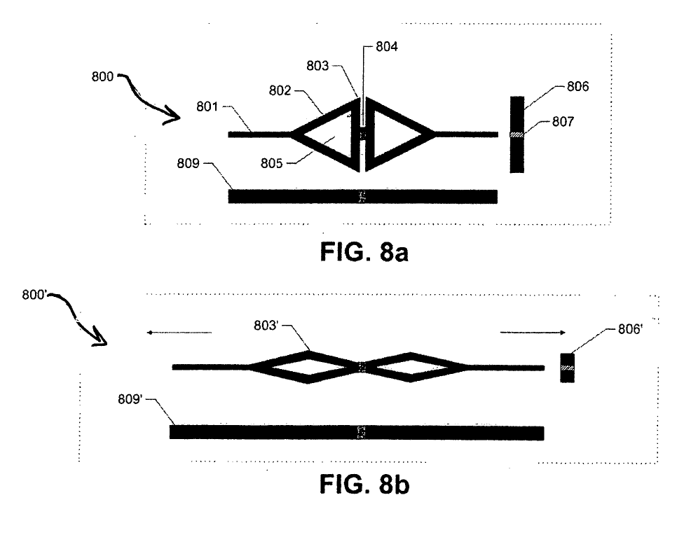

FIG. 7a shows end-tab 120 with a tapered slot 109 that leads into hole 102′ thus allowing a node pin to enter into hole 102′ from the side, like putting on hand-cuffs. Like end-tab 100, it also supports sliding the node pin end-first into hole 102′ like threading a needle eye. Because the taper on slot 109 is larger on the outside and narrower near hole 102′ it easy for the user to slide the end-tab sideways onto the node pin, but it is difficult for it to come back out of the hole. Also, because the direction of the model's normal tension is perpendicular to the direction of slot 109, the design of end-tab 120 prevents unintentional disassembly.

Node pin 140 in FIG. 7b uses collars 141 that can be slide along the pin by the user but the collar hole 142 is sized so that, when it is at rest, it grips onto the node pin 140 to sandwich and hold in place multiple end-tabs. The user can disassemble a node by sliding off one of the collars and letting the end-tabs fall off the node pin. It will be appreciated that collar 141 could also be a cap that encloses the end of the node pin. A benefit of the design of node pin 140 with collars 141 is that it allows convenient application of sheet coverings on a model's facets. After completing a skeletal model, sheets of paper or fabric that match the shape of a facet, but are slightly larger, can be affixed to the model by punching holes in the sheet so that they align and slide over each node pin 140. Remove the collar, place the sheet onto the node pin, and then re-install the collar to hold the sheet in place. The model is thus transformed from a skeletal shape into a solid-appearing shape.

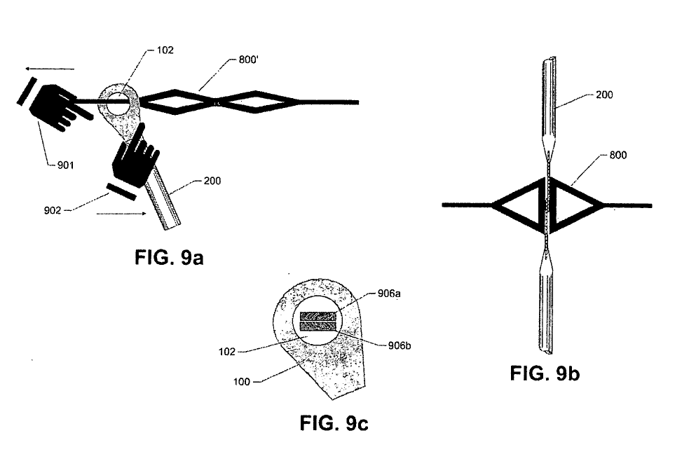

Node pin 800 in FIG. 8a allows end-tabs to be affixed by a push-pull action onto the center of the pin at axis point 804. Holding wall 803 gradually tapers to meet gripping and mating section 801 of the node pin. Both the holding wall 803 and taper section 802 are flexible. When the pin is stretched along the pin's main axis it causes the holding wall 803 to fold back and flatten out and the taper section 802 to flatten out as shown in FIG. 8b. In top-view at reference numeral 809′ the increase in length is seen while in end-view at reference numeral 806′ the diminished height of holding wall 803′ is seen. The overall effect is to lessen the height of the holding wall 803′, such that, tab hole 102′ can easily slide onto axis point 804. When the node pin 800 is returned to rest state, holding wall 803 returns to an orientation (generally) perpendicular to the pin's axis to sandwich and hold one or more end-tab faces 101 in place in an orientation also generally perpendicular to the pin axis. Note that the exemplar design of node pin 800 has a taper section in one dimension only. Top-view 809 and end-view 806 show that the other dimensions are simply rectangular, as if the piece was sliced from an extrusion. It will be appreciated, however, that a pin 800 could be made where there is a uniform conical taper section and circular holding wall.

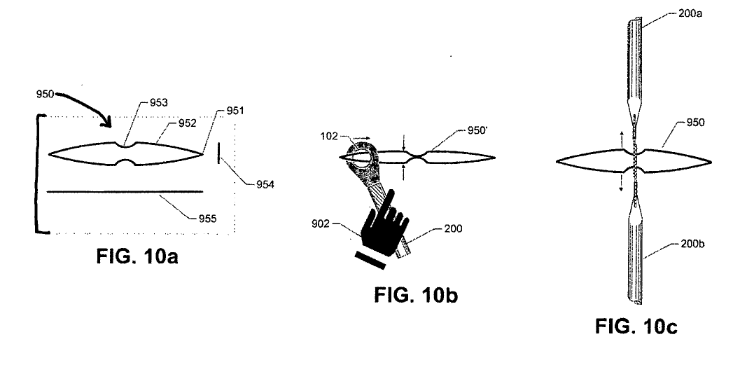

FIG. 9a demonstrates how a strut is affixed onto node pin 800. The end user threads the end-tab through section 801 which is smaller than the diameter of hole 102′. One hand 901 pulls grip section 801 away from the pin's center, while the other hand 902 pushes the tab face against taper section 802. The taper section flattens against this force, reducing the height of the holding wall to where the tab slides into the center section 804. FIG. 9b shows multiple struts being held in place with node pin 800 at rest. The struts can now rotate around the axis of the pin and flex in any direction. To remove a strut, the same procedure is done in the reverse direction to slide one or more tabs off the center and onto mating section 801.

The dimensions of the grip and mating section 801 are important for the operation of bonding two nodes onto a single node (as described below). Section 801 is sized so that two mating sections can easily fit inside tab hole 102′ as shown in FIG. 9c. Mating sections 906a and 906b can be laid upon each other and held by the hand as if they were a single unit. Even doubled up, there is still ample room for a tab to slide onto the mating section. The tabs on the node to be eliminated, say 906a, are slid off onto this dual mating section and then node pin 906a is removed. All removed end-tabs are now on the mating section of node pin 906b. Those tabs can then be slid with the aforementioned push-pull action onto the center of node pin 906b.

To demonstrate exemplary operation of the illustrated embodiment, consider a model builder constructing a 3D geometric structure by beginning with a basic 2D shape. Typically, building will be done using struts of equal length. The builder will thus start out forming an equilateral triangle. Constructing such a triangle is an intuitive process whereby three struts are intersected at their end tabs. In this state, each intersection will have, for example, two tabs 110 aligned and pinned flat against each other through their holes 102 by a single node pin 130. When observing this 2D triangle it is very easy to see how to make a 3D tetrahedron structure. Simply affix one more strut at each vertex of the triangle, i.e., slide the end tab 110 over each node pin so that it stacks against the existing two end tabs. Then each of these new struts is rotated around the node pin and flexed up from the 2D plane in such manner that the opposite end tabs of all three new struts intersect at their holes 102 and are then pinned by a new node pin 130. The builder now has a 3D structure that has four triangular facets. Just as the original triangle was extended in 3D space to form a tetrahedron, the builder can now easily see how to extend out from each triangular facet to create four tetrahedron forms around the original tetrahedron. This intuitive build-out process can be repeated on-and-on, as each new structure will always have facets to extend out from. If the builder continues building around a single node of the original tetrahedron, an icosahedron structure will result. The icosahedron structure has twenty triangular facets. Each facet may be extended out with tetrahedrons to create a structure known as a ‘stellated’ icosahedron. At this point, however, the build-out will end—there is no regular shape that can be created by extending out from the facets of the outer tetrahedrons in a stellated icosahedron, showing that tetrahedrons alone cannot fill space. In order to fill space around the icosahedron, the builder must build-out using a combination of 3-sided tetrahedron structures and 4-sided pyramid structures (a 3D structure comprised of a square base with four equal length struts intersecting above the base, i.e., one-half of an octahedron). By studying the pattern of outer edges and facets of the icosahedron, and by experimentation (i.e., trial and error), the builder can deduce a regular pattern of tetrahedrons and octahedrons that can enclose a shell around the original icosahedron. Building-out this pattern results in a regular polyhedron with the icosahedron at the core. Note that building out successive shell layers will eventually result in the quasi-form of a C60 Fullerene (i.e., a BuckyBall) object. While icosahedron-based structure variations are very interesting to explore, there are many other base structures to use as starting points to build quasi-crystalline objects.

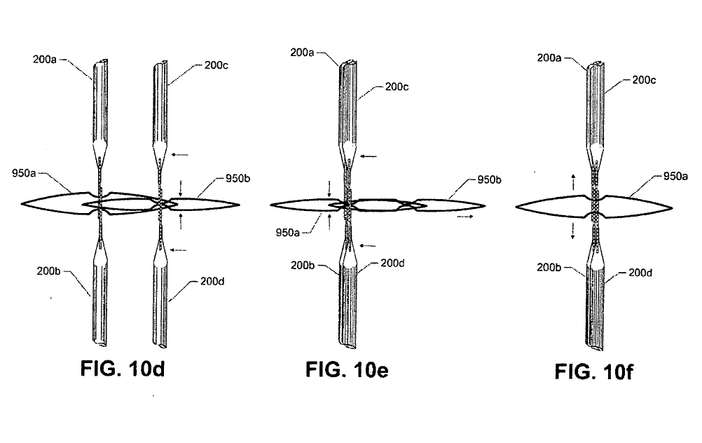

Node pin 950 in FIG. 10a allows end-tabs 100 to be affixed by a pushing them over tensioned, taper section 952 and onto center axis section 953 where it is held in place by outward tension. Node pin 950 is easily inserted into tab hole 102 at starting tip 951 because it is smaller than the diameter of hole 102. Taper section 952 gradually increases symmetrically in width until it becomes greater than the diameter of hole 102. It then tapers sharply back down again leading to center axis section 953. Because of its gradual taper, the force of pushing tab 100 along taper section 952 compresses it thereby reducing the height of pin 950, as viewed from side-view 954, allowing tab hole 102 to freely pass into center axis section 953. This operation is shown in FIG. 10b where node pin 950′ is in its compressed state and end-tab 100 of strut 200 is being slid onto the pin. The height of pin 950 can also be reduced by squeezing section 952 between the fingers then sliding tab 100 into the center axis section 953. When taper section 952 flexes back to its normal state, center axis section 953 returns to a width that is also greater than the diameter of hole 102 exerting outward pressure on hole 102. Because axis section 953 is tapered, it forces tab 100 to the center of the axis section 953. Multiple end-tabs 100 are thereby sandwiched together in the center by the combination of outward pressure of axis section 953 and the taper of axis section 953. Note that this action is in contrast to the design of node pin 800 that sandwiches end-tabs 100 together by side-pressure from holding wall 803. FIG. 10c shows multiple end-tabs 100 sandwiched onto node pin 950 in its normal, at-rest, state.

FIG. 10d, FIG. 10e and FIG. 10f illustrate a bonding operation using node pin 950. In FIG. 10d, the tip 951 of node pin 950b is partially inserted into the holes 102 of the end-tabs 100 that are stacked on node pin 950a. Similarly, the tip 951 of node pin 950a is partially inserted into the end-tabs 100 that are stacked on node pin 950b. Node pin 950b is squeezed to reduce its height and struts 200c and 200d are slid toward the center of node pin 950a. In FIG. 10e taper section 952 of node pin 950a compresses allowing struts 200c and 200d to move into center section 953 of node pin 950a. Node pin 950b is now free of struts 200a and 200b and is removed from the model, leaving node pin 950a to serve as the node for the combined struts 200a, 200b, 200c and 200d.

It will be appreciated that node pin 950 could be a piece with an open interior, such as a wire frame, or a solid piece, such as, a molded sponge rubber piece. Top-view 955 and side-view 954 pertain to a wire frame design and illustrate, that here, the thickness of the piece is narrower than the height or length of the piece.

A simple node pin, e.g., a ribbed cylinder 130, can be used successfully in many applications. Node pins as illustrated at reference numerals 800 and 950 are considered practical to work with the hands due to an ease of workability. In node creation operations, these node pins allow for an easy ‘thread and click’ operation. By contrast, the “Pin and Collar” node pin at reference numeral 140 is not quite as easy to work because it includes two elements and requires more handling. In bonding operations, node pins at reference numerals 800 and 950 provide a way for the two node pins of interest to overlap such that the end-tabs will exist, during an intermediate stage, on both node pins, followed by an action where one node pin is removed and the new end-tabs are now safely transferred over to a single node pin. This is not as easily accomplished with the non-overlapping cylindrical node pins at reference numerals 130 or 140 where the pins do not overlap during tab transfer. Thus in node pins at reference numerals 800 and 950, the user is spared from the possibly of losing an entire stack of end-tabs at the moment they have been slid completely off the ‘giving’ node pin and just before they have been slid onto the ‘receiving’ node pin. Losing a stack of unsecured end-tabs can be unfortunate when working with bonding complex sub-structures.

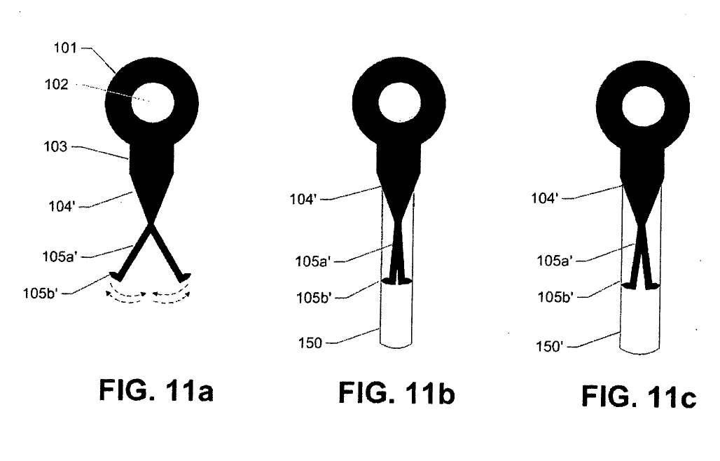

FIG. 11a shows an alternative embodiment of an end-tab 100 that allows it to fit in varying interior diameters of tube section 150. In FIG. 11a, tab stop 104′ is now a tapered section that will bottom-out with tube 150 anywhere along its length. Tab stop 104′ can be a tapered flat shape or a conical shape. To hold the end-tab 100 firmly in place, outward gripping force is exerted by insertion section 105 by two moveable, and side-ways tensioned legs 105a′ that have barb-like feet 105b′. To place the end-tab 100 into the end of tube 150, the user squeezes legs 105a′ together and then pushes end-tab 100 into tube 150. By design, feet 105b′ do not grip going into the tube, but with outward pressure exerted by legs 105a′, they generally dig into the interior wall of tube 150 to prevent the end-tab from sliding out. FIG. 11b shows an inserted end-tab 100 in a tube 150 of a particular diameter. FIG. 11c shows end-tab 100 inserted into tube 150′ with a larger diameter.

While a number of particular embodiments of the invention have been shown, including variation in shape and structure of end-tabs, node pins, pin aperture and the like, it will be understood that such various embodiments can be mixed and matched in combinations other than those specifically illustrated herein and that adaptation in forming such additional combinations may be employed. For example, while a serrated hole 102 works well with node pins 130 and 132 of FIG. 1c a round hole 102 can be used with other node pins such as pins 140, 800 and 950.

The variety and scale of geometric models that can be built with embodiments of the invention is very great, yet it is simple and intuitive to realize this variety and scale. Once started, the model itself presents the next steps that are possible. Ultimately, the direction the model takes is dependant upon what the builder visualizes to do at each outer edge or facet. Here, struts are added to the node pins, rotated and flexed in any directions to intersect in space per the builder's visualization. The end result in its entirety need not, and likely cannot, be visualized beforehand, but it can be done one step at a time.

Using embodiments of the invention a large structure can be built by mating (i.e., bonding) several smaller structures together at their node points. Visualizing a large structure and building it one strut at a time from start to finish can be very difficult. It becomes much easier with a divide-and-conquer strategy, i.e., independently build several complex sub-structures using equal or proportionate strut lengths, and then combine the sub-structures to create the larger and even more complex final structure.

An important design parameter is strut length. Strut length can be varied to create particular spatial relationships between nodes in three-dimensional (3D) space. Struts will commonly be of equal length; however, a mixture of lengths that are related by various mathematical ratios is also interesting to study. Model complexity is directly proportional to the number of nodes in the structure and the positional relationships of the nodes as determined by the strut lengths.

Another, useful technique to build structures is to create sub-structures independently. Here the builder assembles a final structure by bonding the sub-structures together at a single node, at a single edge or at a single facet. To bond at a point, the selected node points of each structure are placed against each other. The end-tabs of one structure are slid off of its node pin onto the corresponding node pin of the other structure. To bond along an edge, the selected struts of two independent structures are aligned parallel to each other. At each end of the aligned struts, the end-tabs of one node are slid over to the node pin of the other structure. To bond at a facet, a triangular facet for example, the builder simply aligns the facets of each independent structure, then slips the end-tabs of each of the three aligned nodes onto a single node pin. After bonding, the facet will now be internal to the new structure and two parallel struts between each node of the triangle will exist.

Exploration of the 3D structures based upon varied strut lengths, per mathematical ratio formulas or even free-form, is accomplished by cutting the strut shafts to desired length, affixing the end-tabs, then building models using the same operations described above.

In conclusion, embodiments of the invention provide complete freedom to position the strut elements in any direction in order to form intersections. The means by which strut intersections are fixed into position assures that the model can easily extended in space and will bear its own weight no matter how large the model grows. Models can be easily and quickly disassembled. These capabilities are not provided by known stick and hub construction designs. Embodiments of the invention have multiple advantages, that taken together, make it practical for the builder to create models of higher node count, hence more complexity and beauty, than known geometric modeling systems.

It will be appreciated that the present invention is not restricted to the particular embodiments that have been described and illustrated, and that variations may be made therein without departing from the scope of the invention as found in the appended claims and equivalents thereof.

What is claimed is:

1. A strut for a geometric modeling, the strut comprising:
a shaft section having a first end and a second end;
a first node connector element;
a second node connector element;
a first flexible section coupling said first node connector element and said first end; and
a second flexible section coupling said second node connector element and said second end.

2. A strut according to claim 1 wherein said shaft comprises a rigid element.

3. A strut according to claim 1 wherein said first node connector element comprises a planar element having an aperture therein and comprising a pin element positionable therethrough and in normal relation to said planar element.

4. A strut according to claim 1 wherein said shaft comprises a tubular element.

5. A strut according to claim 1 wherein said first node connector element comprises a first planar element having a first aperture, said second node connector element comprises a second planar element comprising a second aperture therein and comprising a pin element positionable therethrough and in normal relation to said planar element.

6. A strut according to claim 1 wherein said strut includes a first end-tab comprising a first planar element having a first aperture therein, a second planar element as said flexible section, and an insertion section for coupling to said shaft.

7. A strut according to claim 6 wherein said shaft is tubular and said insertion section is adapted to couple to said shaft by insertion therein.

8. A strut according to claim 7 wherein said shaft may be modified in length by cutting thereof while maintaining an ability to receive said insertion section therein.

9. A strut according to claim 1 wherein said first flexible section provides flexibility in at least one of compression, contraction, and stretching.

10. A strut according to claim 1, wherein said first node connector element comprises a planar element having an aperture therein, in combination with a node pin adapted for engaging said aperture to pin a second planar node connector element in stacked parallel relation and in rotatable relation to said node pin.

11. A geometric skeletal modeling system comprising:
a plurality of coupling elements; and
a plurality of struts, each strut including a shaft section, a first planar end, a second planar end, a first flexible section coupling a first end of said shaft and said first planar end, and a second flexible section coupling a second end of said shaft and said second planar end, said coupling elements being adapted to couple selected planar ends of different struts in face-to-face relation.

12. A system according to claim 11 wherein said coupling elements comprise pins and said selected planar ends include apertures therethrough.

13. A system according to claim 12 wherein a selected one of said pins inserts in normal relation to said selected planar ends and maintain said selected planar ends in face-to-face relation while allowing rotation thereof about an axis of said selected one of said pins.

14. A system according to claim 11 wherein each of said struts comprise a tubular shaft, a first end-tab as said first planar end and said first flexible section, and a second end-tab as said second planar end and said flexible section.

15. A system according to claim 14 wherein each of said end-tabs comprise a coupling element for attachment to said tubular shaft.

16. A system according to claim 15 wherein said attachment is by insertion into said tubular shaft.

17. A system according to claim 16 wherein said tubular shaft may be cut to selected length while preserving an ability to receive said end-tabs.

18. A system according to claim 11 wherein system includes a plurality of apertures, each first planar element and each second planar element include at least one of said apertures therethrough and wherein said coupling elements comprise node pins adapted for engaging selected ones of said apertures and securing in stacked relation corresponding selected ones of said planar elements.

19. A system according to claim 18 wherein said node pins comprise axially extendable elements having a first outer diameter when in a rest state and a lesser second outer diameter in an axially stretched state, said first outer diameter being greater than a diameter of said apertures, said second outer diameter being less than said diameter of said apertures.

20. A system according to claim 19 wherein each of said node pins include first and second holding walls in face-to-face relation and capturing therebetween said corresponding selected ones of said planar elements.

21. A system according to claim 18 wherein said node pins comprise laterally compressible elements having a first outer diameter when in a rest state and a lesser second outer diameter in an axially stretched state, said first outer diameter being greater than a diameter of said apertures, said second outer diameter being less than said diameter of said apertures.

22. A system according to claim 21 wherein said node pins include a central valley section capturing therein said corresponding selected ones of said planar elements.

23. A system according to claim 21 wherein said node pins are adapted in dimension relative to said diameter of said aperture whereby at least two of said node pins can occupy one of said apertures.

24. A method of constructing a geometric model comprising the steps:
coupling together a first strut and a second strut with a node pin by placing said pin in normal relation to a first planar face of said first strut and a first planar face of said second strut;
coupling a third strut to said first and second struts by placing said pin in normal relation to a first planar face of said third strut;
urging at least one of said first, second, and third struts into non-planar relation relative to the other two of said first, second, and third struts by flexing a length section of at least one of said first, second, and third struts, said length section being less than a full length of said at least one of said first, second, and third struts.

25. A method according to claim 24 wherein said urging step comprises flexing each of said first, second, and third struts.

26. A method according to claim 24 wherein a plurality of struts, including said first, second, and third struts, are coupled to form a three dimensional model with each strut having at each end thereof a planar face, selected planar faces of selected struts being coupled by selected pins placed therethrough to form selected nodes.

27. A method according to claim 26 wherein a plurality of struts are coupled together form a first geometric structure, each of said plurality of struts including a central length section, a first and second planar face, and a first and second flexible length section, the first flexible length section being interposed between a first end of said central length section and said first planar face, the second flexible length section being interposed between said second planar face and a second end of said central length section.

28. A method according to claim 27 wherein a second geometric structure couples to said first geometric structure, said second geometric structure being formed from a second plurality of struts similar in structure to said first plurality of struts, said first and second geometric structures being coupled by stacking and securing in parallel relation selected planar faces of said first geometric structure with selected planar faces of said second geometric structure.
